(19) United States
(12) Patent Application Publication
(10) Pub. No.: US 2005/0097750 A1
(43) Pub. Date: May 12, 2005

(54) Vehicle door frame and method for manufacturing the same

(75) Inventor: Satoshi Masunaga, Anjo-shi (JP)

Correspondence Address: BURNS DOANE SWECKER & MATHIS L L P, POST OFFICE BOX 1404, ALEXANDRIA, VA, 22313-1404, US

(73) Assignee: AISIN SEIKI KABUSHIKI KAISHA, Kariya-shi (JP)

(21) Appl. No.: 10/972,680

(22) Filed: Oct. 26, 2004

(30) Foreign Application Priority Data
Nov. 7, 2003 (JP) 2003-378790

(51) Int. Cl. B21F 11/00; B23P 11/00

(52) U.S. Cl. 29/897.2; 29/505

(57) ABSTRACT

A method for manufacturing a vehicle door frame including an elongated member formed with a plurality of bending portions in longitudinal direction of the elongated member and having a hollowed main body, a connecting portion extending from the hollowed main body and a flange portion extending from the connecting portion comprises the steps of: an elongated member forming step for forming the elongated member at which the hollowed main body, the connecting portion and the flange portion are formed integrally; a liner inserting step for inserting a liner into the hollowed main body; a slit forming step for forming a slit at the connecting portion; a bending portion forming step for forming a bending portion; a notch portion forming step for forming a notch portion by trimming off a part of the flange portion and the connecting portion, and a vehicle door frame finishing step for finishing the vehicle door frame by fixing a bracket into the notch portion.

### CROSS REFERENCE TO RELATED APPLICATIONS

This application is based on and claims priority under 35 U.S.C. § 119 to Japanese Patent Application 2003-378790, filed on Nov. 7, 2003, the entire content of which is incorporated herein by reference.

### FIELD OF THE INVENTION

This invention generally relates to a vehicle door frame and a method for manufacturing the same.

### BACKGROUND

A known seat slide device disclosed in JP2002127749A includes an elongated member forming process, a liner inserting process, a first bending portion forming process, a notch portion forming process, a second bending portion forming process and a vehicle door frame finishing process. In the elongated member forming process, an elongated member having a hollowed main body and a flange portion in predetermined cross section is made of a sheet material. In the liner inserting process, a liner is inserted into the hollowed main body of the elongated member at a predetermined portion in longitudinal direction thereof. In the first bending portion forming process, the elongated member is bent at the predetermined portion thereof where the liner is inserted so as to form a bending portion having large curvature radius (e.g. more than or equal to curvature radius 110 mm). In the notch portion forming process, the predetermined portion of the flange portion corresponding to the bending portion having large curvature radius formed in the first bending portion forming process is trimmed off so as to form a notch portion. In the second bending portion forming process, the elongated member is further bent at the predetermined portion to form a bending portion having small curvature radius (e.g. a curvature radius from 20 mm to 500 mm). Finally, in the vehicle door frame finishing process, a bracket is fixed into the notch portion formed at the elongated member. In this way a vehicle door frame is manufactured.

Specifically, in the first bending portion forming process, the elongated member is pressed to a bender having large curvature radius with applying tension so as to form the vending portion having large curvature radius. In the first bending portion forming process, the bending portion having large curvature radius is formed without harming the shapes of the hollowed main body and the flange portion.

Further, in the notch portion forming process, the flange portion of the elongated member including the bending portion having large curvature radius is trimmed off so as to form the notch portion, and such notch portion can prevent the flange from being damaged when the bending portion having large curvature is further bent to form the bending portion having small curvature radius in the second ending portion forming process. Specifically, the elongated member at the bending portion having large curvature consists of only the hollowed main body at this point because the flange portion corresponding to such bending portion is trimmed off in the notch portion forming process. Thus, the elongated member can be easily bent due to the notch portion formed in the second bending portion forming process.

Furthermore, in the second bending portion forming process, both ends of the elongated member are firmly fixed at wide range thereof by clamps without harming the shape of the elongated member. With applying tension to portions of the elongated member where the bending portion having small curvature radius is not formed, and then the bending portion having large curvature radius is further bent to form the bending portion having small curvature radius. Finally, in the vehicle door frame finishing process, an additional flange member is fit into the notch portion of the elongated member including the bending portion having small curvature radius. In this way, the bending portion having small curvature radius is formed at the vehicle door frame in stages, such as first and second bending portion forming processes, as a result, freedom in design of the door frame is enhanced by such manufacturing method.

According to the structure of the elongated member, the flexural strength of the hollowed main body is smaller than the flexural strength of the flange portion having relatively small. More specifically, the flange portion would have been fractured if the hollowed main body and the flange had been bent at the same time with tension corresponding the flexural strength of the hollowed main body to form the bending portion having small curvature radius.

Thus, in the first bending portion forming process of the known manufacturing process, tension by which the flange portion is not fractured is applied to the elongated member and pressed to the bender having the curved shape with large curvature radius. Thus, the bending portion having large curvature radius (e.g. equal to or more than 110 mm of curvature radius) is formed at the elongated member.

Further, in the second bending portion forming process of the known manufacturing process, the bending portion having small curvature radius is easily formed by bending only the hollowed main body of the bending portion having large curvature radius of the elongated member because the notch portion is provided at the bending portion by trimming off the flange portion thereof. To bend such hollowed main body, smaller tension relative to the tension required in the first bending portion forming process is needed. Thus, the bending portion having small curvature radius (e.g. from 20 to 50 mm of curvature radius) is formed at the elongated member.

Through such method for manufacturing the vehicle door frame, the elongated member is bent in stages such as the first and the second bending portion forming processes, further, in each stage, the strength of the tension must be changed depending on the flexural strength of the bent portion of the elongated member. Such configuration complicates the operation in each stage such as the first and the second bending portion forming processes. Thus, the manufacturing cost for manufacturing the vehicle door frame is increased.

In addition, according to the known manufacturing method, the each end of the elongated member is firmly secured at the enough range by a clamp to form the bending portion having small curvature radius in the second bending portion forming process. Specifically, in such configuration, the each range of the elongated member being secured by the clamp should be sufficient in length, in other words, the bending portion having small curvature radius can be formed only at approximately the center portion of the elongated member. In this point of view, it would not be considered that freedom in design of the door frame is enhanced by such manufacturing method, further, it would not be considered that flexibility in design of the door frame is performed.

Thus, a need exists for the method for manufacturing the vehicle door frame to form a bending portion having small curvature radius with reducing the manufacturing cost thereof. In addition another need exists for the method for manufacturing the vehicle door frame to provide a vehicle door frame which can expand the freedom in design thereof and perform the flexibility in design thereof.

### SUMMARY OF THE INVENTION

According to an aspect of the present invention, a method for manufacturing a vehicle door frame including an elongated member formed with a plurality of bending portions in longitudinal direction of the elongated member and having a hollowed main body, a connecting portion extending from the hollowed main body and a flange portion extending from the connecting portion comprises the steps of:
an elongated member forming step for forming the elongated member at which the hollowed main body, the connecting portion and the flange portion are formed integrally;
a liner inserting step for inserting a liner into the hollowed main body of the elongated member at a predetermined position thereof after the elongated member forming step;
a slit forming step for forming a slit at the connecting portion at the predetermined position thereof after the liner inserting step;
a bending portion forming step for forming a bending portion by bending the elongated member after the slit forming step;
a notch portion forming step for forming a notch portion by trimming off a part of the flange portion and the connecting portion positioned outside of the slit after the bending portion forming step, and
a vehicle door frame finishing step for finishing the vehicle door frame by fixing a bracket into the notch portion of the elongated member after the notch portion forming step.

According to another aspect of the present invention, a vehicle door frame includes an elongated member where a plurality of bending portions is formed in longitudinal direction of the elongated member and having a hollowed main body, a connecting portion extending from the hollowed main body and a flange portion extending from the connecting portion, wherein at least one of the bending portions is formed at the end portion side of the elongated member in longitudinal direction thereof by extrusion of roll forming, and curvature radius of the bending portion formed at the end portion side of the elongated member is smaller than curvature radius of the flange portion at which a limit value of flexural strength is applied.

### BRIEF DESCRIPTION OF THE DRAWINGS

The foregoing and additional features and characteristics of the present invention will become more apparent from the following detailed description considered with reference to the accompanying drawings, wherein:

FIG. 1 illustrates a flow chart of a method for manufacturing the vehicle door frame in the embodiment according to the present invention;

FIG. 2 illustrates a enlarged perspective view of an elongated member in the embodiment according to the present invention;

FIG. 3 illustrates a overall front view of an elongated member in a liner inserting process in the embodiment according to the present invention;

FIG. 4 illustrates an enlarged perspective view of the elongated member in a slit forming process in the embodiment according to the present invention;

FIG. 5 illustrates an overall front view of the elongated member in a bending portion forming process in the embodiment according to the present invention;

FIG. 6 illustrates an overall front view of the elongated member in a notch portion forming process in the embodiment according to the present invention;

FIG. 7 illustrates an overall front view of the elongated member in a vehicle door frame finishing process in the embodiment according to the present invention;

FIG. 8(A) illustrates an overall front view of the vehicle door frame including a bending portion at approximately the center of the elongated member in the embodiment according to the present invention; and

FIG. 8(B) illustrates an overall front view of the vehicle door frame including a bending portion at the end portion of the elongated member in the embodiment according to the present invention.

### DETAILED DESCRIPTION

An embodiment of the present invention will be explained hereinbelow referring to attached drawings.

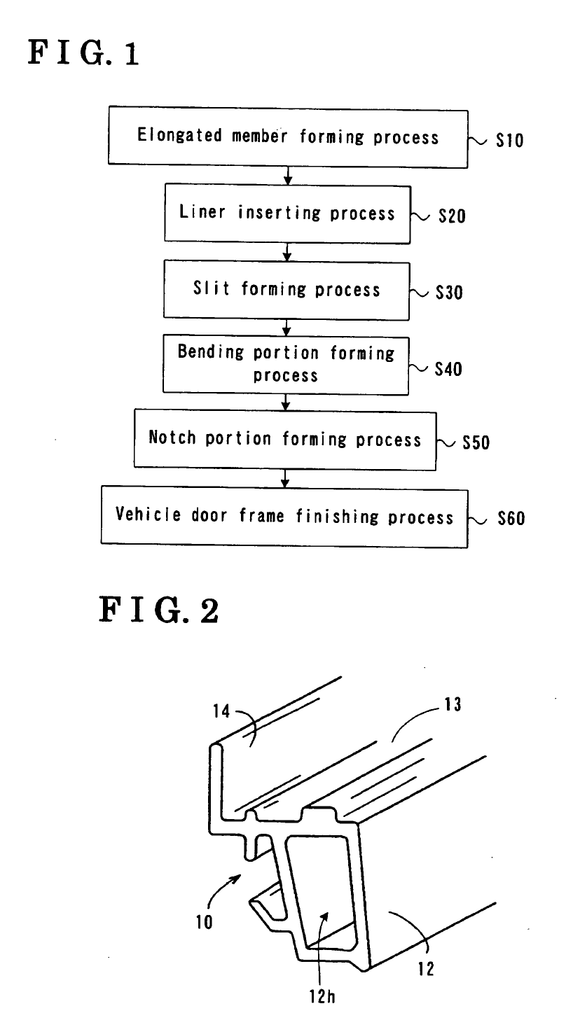

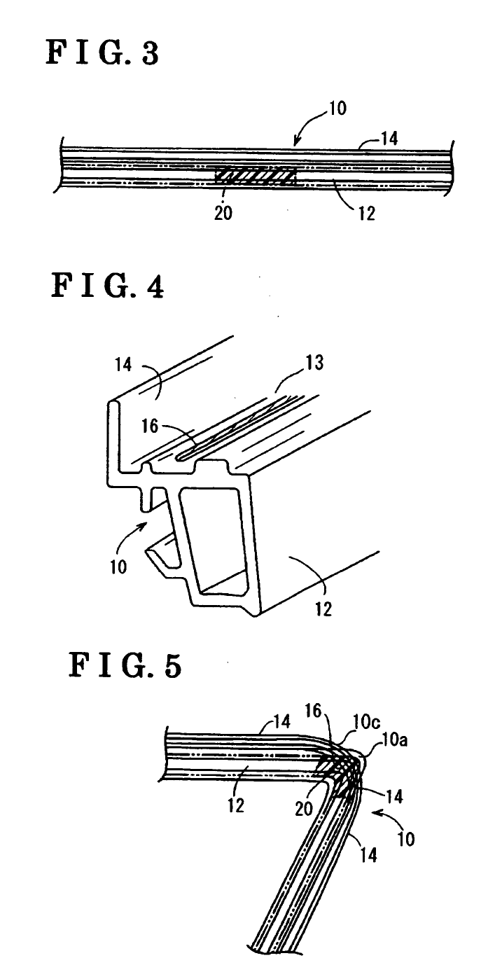

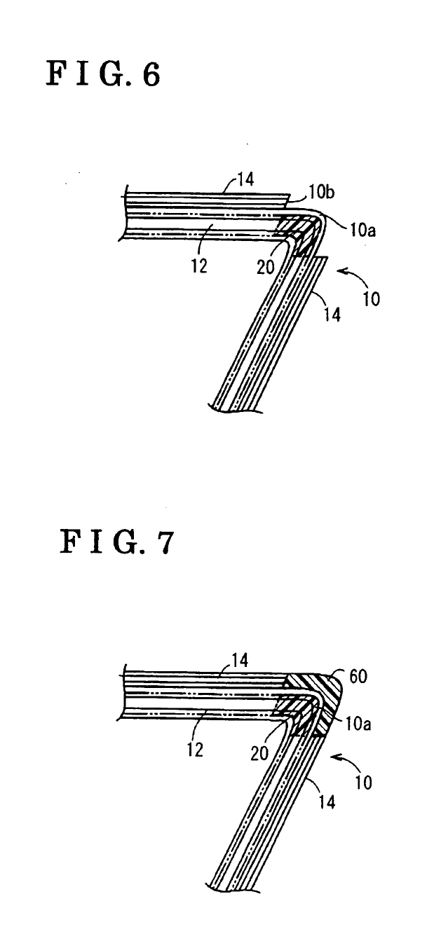

As shown in FIG. 1, firstly an elongated member 10 is formed in an elongated member forming process S10 (elongated member forming step). Specifically, the elongated member 10 having a predetermined form in section as shown in FIG. 2 is formed by extruding light-alloy such as aluminum by means of an extruder. The elongated member 10 includes a hollowed main body 12, a connecting portion 13 and the flange portion 14. The hollowed main body 12 includes a hollow 12h at the center thereof, and the flange portion 14 extending in upper direction in FIG. 2 is integrally connected to the hollowed main body 12 with the connecting portion 13 formed therebetween. Thus, the elongated member 10 at which the hollowed main body 12, the connecting portion 13 and the flange portion 14 are integrally formed at the elongated member forming process S10.

When steel is used as material, the elongated member 10 including the aforementioned form in section may be formed by means of a roll forming.

Then, in a liner inserting process S20 (liner inserting step) in FIG. 1, a liner 20 formed separately is inserted into the hollow 12h of the hollowed main body 12 at a predetermined position where a bending portion 10a is supposed to be formed, such as a center portion of the elongated member 10 or approximately end portions of the elongated member 10. The liner 20 is provided as reinforcement for keeping the shape of the hollowed main body 20 while the elongated member 10 is bent. Further, the liner 20 is provided at the elongated member 10 so that a peak of the bending portion 10a having smaller curvature radius is to be approximately a center portion of the liner 20.

If the elongated member 10 is bent to form a bending portion having large curvature radius, the liner inserting process S20 may be skipped.

Then, in a slit forming process S30 (slit forming step), a roll by which a slit is formed on the elongated member 10 is attached to the roll forming machine (not shown), and then the elongated member 10 is inserted thereinto so as to form a slit 16 at the connecting member 13 provided between the hollowed main body 12 and the flange portion 14 of the elongated member 10 as shown in FIG. 4 by the roll attached to the roll forming machine. The slit 16 being penetrating through the elongated member 10 is formed at entire portion of an after-mentioned bending portion.

A laser machine of a pressing machine may be used alternatively to form the slit 16.

Then, in the bending portion forming process S40 (bending portion forming step), the elongated member 10 is pressed to a bender (not shown) having small curvature radius with applying tension to the elongated member 10 at both edges thereof. Thus, a bending portion 10a having small curvature radius is formed at the elongated member 10 at the portion where the liner 20 is inserted. At this point, the slit 16 is formed at the connecting portion 13 provided between the hollowed main body 12 and the flange portion 14 so that only the hollowed main body 12 is bent easily to fit to the shape of the bender having small curvature radius. Thus, the elongated member 10 can be bent at the portion where the slit 16 is formed in a single stage. In this way, a bending portion 10a having small curvature radius (e.g. 20-50 mm curvature radius) is formed at the elongated member 10 by a single bending operation. In this embodiment, the curvature radius of the bending portion 10a is set to be 40 mm. The amount of the tension applied at the each end portion is determined to be in a range where the material of the elongated member 10 is not elongated.

The length of the slit 16 is the same as the length of the outer circumference of the bending portion 10a having small curvature radius of the hollowed main body 12 of the elongated member 10. Thus, a part of the connecting portion 13 and the flange portion 14 positioned outside of the slit 16 is separated from a part of the connecting member 13 and the hollowed main body 12 positioned inside of the slit 16, and the other part of the connecting member 13 and the flange portion 14 are integrated with the hollowed main body 12.

As the bending portion having small curvature radius 10a is formed, the part of the flange portion 14 positioned outside of the slit 16 is also bent to form a bending portion 10c having large curvature radius, but not beyond the limit value of the flexural strength of the flange portion 14. Specifically, the curvature radius of the bending portion 10a is smaller than the curvature radius of the bending portion 10c being under the limit value of the flexural strength of the flange portion 14.

Then, in a notch portion forming process S50 (notch portion forming step), a notch portion 10b is formed by trimming off the part of the flange portion 14 and the connecting portion 13 positioned outside of the slit 16. Specifically, the notch portion 10b can be formed by cutting both edges of the bending portion having large curvature radius, in other words, by cutting along the lines connecting each end of the slit 16 and each end of the outer circumference of the bending portion 10c having large curvature radius so that the part of the connecting portion 13 and the flange portion 14 positioned outside the slit 16 is trimmed off. Thus, the notch portion 10b is formed easily.

Then, in a vehicle door frame finishing process S60 (vehicle door frame finishing step), a bracket 60 whose shape in cross section is identical with the shape of the notch portion 10b in cross section is attached by welding and the like for compensating the notch portion 10b of the elongated member 10. In this manner, the vehicle door frame is manufactured.

According to the method for manufacturing the vehicle door frame in this embodiment, the elongated member 10 is bent in a single stage, not like the known manufacturing method for bending the elongated member 10 in stages. Further, the amount of the tension may not be changed, and the bending portion forming process is performed by the single bender in the bending portion forming process S40 because the elongated member 10 is bent in one step. On this account, the bending portion forming process S40 can be simplified, thus the manufacturing cost can be reduced.

In this way, according to the embodiment of the present invention, the bending portion 10a having small curvature radius can be formed with reducing the production cost.

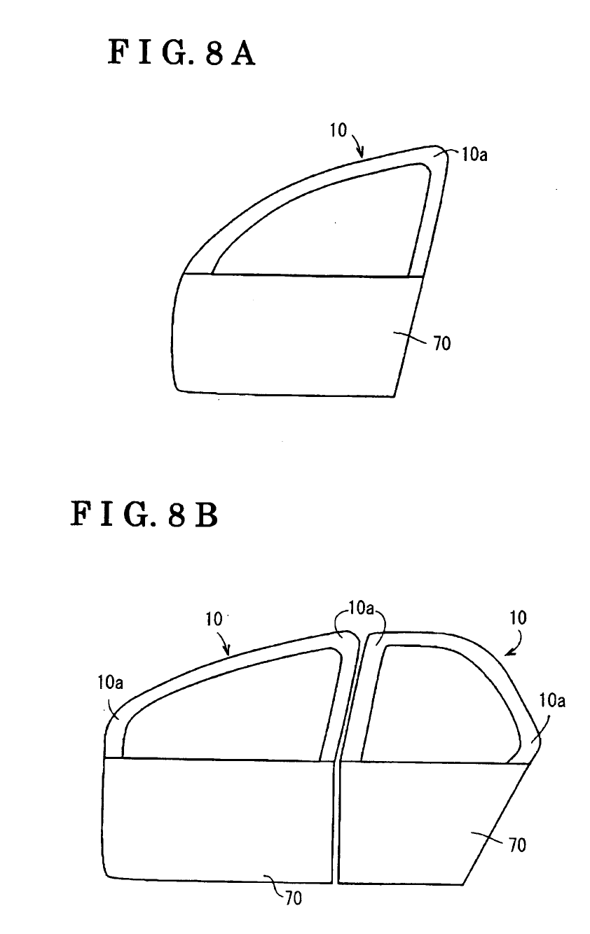

FIGS. 8(A) and (B) illustrate examples of the vehicle door frame manufactured by the method for manufacturing the embodiment according to the present invention.

The door frame in FIG. 8(A) includes a gentle curve extending from the left side toward the upper right in FIG. 8(A). A bending portion 10a having small curvature radius is formed at approximately the center portion of the elongated member 10. Such vehicle door frame is provided at the top portion of a vehicle body 70.

Another example of the vehicle door frame is shown in FIG. 8(B). The door frame includes a bending portion 10a having small curvature radius at approximately the center of the elongated member 10 in longitudinal direction thereof formed by extrusion. Further, another bending portion 10a is formed at the end of the elongated member 10. In this manner, the elongated member 10 includes a plurality of the bending portions 10a in longitudinal direction of the elongated member 10.

In such vehicle door frame, the slit 16 is formed at the elongated member 10 so that the bending portion 10a can be provided even at the end portion of the elongated member 10 because there is no need to hold the end portion of the elongated member 10 at long ranges to form the bending portion.

Further, the curvature radius of the bending portion 10a provided at approximately the center of the end portion of the elongated member 10 is smaller than the curvature radius of the flange portion 14 bent at below the limit value of the flexural strength thereof.

As aforementioned above, the vehicle door frame having a complicated form can be manufactured by forming the bending portion 10a having small curvature radius can be formed at the end portion of the elongated member 10. Thus, freedom in design of the door frame is enhanced by such manufacturing method, further, flexibility in design of the door frame is performed.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the sprit of the present invention. Accordingly, it is expressly intended that all such variations, changes and equivalents which fall within the spirit and scope of the present invention as defined in the claims, be embraced thereby.

1. A method for manufacturing a vehicle door frame including an elongated member formed with a plurality of bending portions in longitudinal direction of the elongated member and having a hollowed main body, a connecting portion extending from the hollowed main body and a flange portion extending from the connecting portion comprising the steps of:
an elongated member forming step for forming the elongated member at which the hollowed main body, the connecting portion and the flange portion are formed integrally;
a liner inserting step for inserting a liner into the hollowed main body of the elongated member at a predetermined position thereof after the elongated member forming step;
a slit forming step for forming a slit at the connecting portion at the predetermined position thereof after the liner inserting step;
a bending portion forming step for forming a bending portion by bending the elongated member after the slit forming step;
a notch portion forming step for forming a notch portion by trimming off a part of the flange portion and the connecting portion positioned outside of the slit after the bending portion forming step, and
a vehicle door frame finishing step for finishing the vehicle door frame by fixing a bracket into the notch portion of the elongated member after the notch portion forming step.

2. A method for manufacturing a vehicle door frame according to claim 1, wherein the length of the slit is the same as the length of the outer circumference of the bending portion.

3. A vehicle door frame including an elongated member where a plurality of bending portions is formed in longitudinal direction of the elongated member and having a hollowed main body, a connecting portion extending from the hollowed main body and a flange portion extending from the connecting portion, wherein at least one of the bending portions is formed at the end portion side of the elongated member in longitudinal direction thereof by extrusion of roll forming, and curvature radius of the bending portion formed at the end portion side of the elongated member is smaller than curvature radius of the flange portion at which a limit value of flexural strength is applied.

4. A vehicle door frame according to claim 3, wherein the curvature radius of the bending portion formed at the end portion side of the elongated member is set to be from 20 mm to 50 mm.

5. A method for manufacturing a vehicle door frame according to claim 1, wherein the liner inserting step further includes a positioning step for positioning the liner so that the center portion thereof becomes a peak portion of the bending portion formed at the elongated member.

6. A method for manufacturing a vehicle door frame according to claim 1, the elongated member forming step further includes a forming step for forming the elongated member by extrusion or roll forming.

7. A method for manufacturing a vehicle door frame according to claim 1, the elongated member forming step further includes a forming step for forming the elongated member by roll forming.

8. A method for manufacturing a vehicle door frame according to claim 1, the slit forming step further includes a forming step for forming the slit at the connecting portion by extrusion or roll forming.

9. A method for manufacturing a vehicle door frame according to claim 1, the bending portion forming step further includes a forming step for forming the bending portion by bending the elongated member with applying tension thereto.

10. A method for manufacturing a vehicle door frame according to claim 1, the bending portion forming step further includes a forming step for forming the bending portion by bending the elongated member with applying tension thereto by which the elongated member is not stretched.
